(19) United States
(12) Patent Application Publication
(10) Pub. No.: US 2006/0024468 A1
(43) Pub. Date: Feb. 2, 2006

(54) Preparation of a substrate

(76) Inventors: Christoph Brabec, Linz (AT); Jens Hauch, Erlangen (DE)

Correspondence Address: FISH & RICHARDSON PC, P.O. BOX 1022, MINNEAPOLIS, MN, 55440-1022, US

(21) Appl. No.: 11/184,493

(22) Filed: Jul. 19, 2005

(30) Foreign Application Priority Data
Jul. 29, 2004 (DE) 102004036794.9

(51) Int. Cl. B44C 1/165; B32B 3/02

(52) U.S. Cl. 428/68; 428/77; 156/230

(57) ABSTRACT

The invention describes a method of preparing a substrate for the fabrication of organic semiconductor components, including the steps of:
affixing a substrate (2) to a carrier (12) by means of an adhesive film;
preparing the substrate (2); and
canceling the adhesive action of the adhesive film so that the substrate (2) can be separated from the carrier (12).

The present invention concerns the preparation of substrates for organic semiconductor components. It particularly concerns the affixing of substrates to carriers by means of an adhesive film and the detachment of substrates from carriers without leaving any residues of the adhesive film.

Organic semiconductor devices offer numerous advantages over conventional—for example silicon-based—semiconductor components. No high-temperature or vacuum processes are needed for their fabrication, thus keeping production costs low. The raw materials are also usually very inexpensive. Organic components can be built on a thin, flexible carrier, so that the components produced are pliable. Their low cost makes them suitable for the mass production of electronic circuits for, among other things, disposable products. One example of the latter is the increasingly widespread use of radio-readable tags, so-called RFID chips, as a substitute for ordinary price tags or the like. However, organic semiconductors are also particularly well suited for high-quality products such as, for example, organic displays, e.g. mobile phone displays, or larger video screens in computer-related applications. Because of the materials used, the disposal of such organic circuits is also less environmentally critical than that of conventional circuits.

The fabrication of organic semiconductor components entails the preparation of thin-layer substrates such as thin films or thin-layer glass plates. These films or glass plates must be mounted on a carrier throughout the process, i.e., during the preparation. These carriers can be glass carriers, for example, if visual inspection or backlighting of the substrate is necessary. To this end, adhesive films are used to affix the substrate and the carrier to each other. After processing, the carrier and the processed substrate film naturally have to be separated from each other again. This means that the adhesive film must be removed without damaging the processed substrate and, insofar as possible, without leaving behind troublesome residues that might hinder further processing steps or adversely affect the operation of the component. Owing to the usually miniscule thickness and generally high sensitivity of substrate films in organic semiconductor components, only a minimum of mechanical force can be applied to remove the adhesive film. Mechanical “abrading” of the film or of residues is therefore out of the question. With previous films, consequently, it has been necessary to use solvents to remove the adhesive layer. This poses the risk that the processed film will be attacked by the solvent, especially when sensitive organic materials are involved. In addition, residues are normally left behind, either by the solvent or by remnants of the adhesive film.

The present invention is intended to solve the problems discussed above. Its object is to provide a method by which the substrate and the carrier can be detached from each other in which no troublesome residues of the adhesive film used remain behind or the substrate is damaged or adversely affected [syntax sic]. The method is to be such that little or no mechanical force and no solvent are required.

This is achieved according to the present invention in that an adhesive film is used that can be detached residue-free without the aid of mechanical force or chemical solvents. To this end, an adhesive film is used whose adhesive action is canceled, for example by a specific temperature step or the introduction of UV light into the film, so that it can be detached residue-free. The adhesive action of the adhesive material is canceled under the effect of heat or UV irradiation, for example the adhesive material becomes gaseous, i.e. evaporates, and escapes. Alternatively, the adhesive layer is immobilized and/or deactivated. Once the adhesive layer has broken down, the carrier and the substrate can easily be separated from each other without damaging the substrate film. The cancellation of the adhesive action is preferably achieved by means of a detaching step.

According to one aspect of the present invention, a method is provided for preparing a substrate for the fabrication of organic semiconductor components. Said method includes the steps of: affixing a substrate to a carrier by means of an adhesive film, preparing the substrate, and canceling the adhesive action of the adhesive film so that the substrate can be separated from the carrier. This method makes it possible to detach the adhesive film without leaving a residue. It is not dependent on chemical solvents or on the use of mechanical force to remove the adhesive layer. This simplifies substrate preparation and is easy on the processed substrate. In addition, there are no solvent residues to dispose of.

It is preferred that the adhesive film be coated with adhesive on both sides and that the affixing of the substrate to the carrier be effected by adhesively bonding the adhesive film to the carrier and adhesively bonding the substrate to the side of the adhesive film facing away from the carrier. This affixing method is easy and effective, and the steps can be performed in any desired manner. Thus, the adhesive film can be affixed to the carrier first or to the substrate first, as need be.

It is preferred that the adhesive film be coated with adhesive on at least one side and that the mounting of the substrate on the carrier be effected by stretch-applying the adhesive film to the carrier, a side coated with adhesive being disposed on the side facing away from the carrier, and adhesively bonding the substrate to the side of the adhesive film coated with adhesive and facing away from the carrier. Stretch application makes for easy attachment to the carrier that is equally easy to undo if necessary. Either the substrate with the adhesive film already adhering to it can be mounted on the carrier, or the substrate is adhesively bonded to the adhesive film stretch-applied to the carrier.

It is preferred for the adhesive film to be composed of a layer of adhesive material whose adhesive action is canceled by the detaching step. Eliminating the use of carrier films for the adhesive film reduces the amount of waste generated during the preparation process; in addition, the possibility exists of providing the carrier or the substrate with the adhesive layer even before preparation.

It is preferred that the adhesive film comprise a carrier film and at least one layer of adhesive material whose adhesive action is canceled by the detaching step. The use of carrier films is known and permits great flexibility during the preparation process. By suitable choice of the properties of the carrier film, the processing of the substrate can be improved, for example by insulating against the thermal and/or UV radiation during the detaching step. In particular, the elastic properties of the carrier film must be suitably selected for stretch application. It is preferred that the adhesive film include a carrier film and two layers of adhesive material, at least one of which two layers comprises an adhesive material whose adhesive action is canceled by the detaching step. Double-sided adhesive films are very easy to use. In this case, at least one of the adhesive layers must have its adhesive action canceled by the detaching step.

It is preferred that one of the two layers comprise an adhesive material whose adhesive action is not canceled by the detaching step. This selectively permits continued adhesion to either the carrier or the substrate after the detaching step, which creates advantages for further processing steps or the end product.

It is preferred that the detaching step include exposing the adhesive film to a set temperature for a set period of time. The introduction of heat is simple, easy to control and inexpensive.

It is preferred that the set temperature be between 80° C. and 110° C. Depending on the type of preparation method, the substrate used and other processing parameters, the temperature and the dwell time can be suitably selected to be as gentle as possible to the end product while at the same time permitting the desired processing.

It is preferred that the set temperature be between 110° C. and 140° C.

It is preferred that the set temperature be between 140° C. and 160° C.

It is preferred that the set temperature be between 160° C. and 180° C.

It is preferred that the detaching step include subjecting the adhesive film for a set period of time to irradiation with UV light having a wavelength between 100 and 240 nm. The use of UV radiation is easy on the substrate, since it is not exposed to any thermal stress. UV light is simple and inexpensive and to use.

It is preferred that the detaching step include subjecting the adhesive film for a set period of time to irradiation with UV light having a wavelength between 100 and 240 nm [duplication sic]. Like the temperature, the wavelength can be selected to suit the parameters of the preparation process.

It is preferred that the detaching step include subjecting the adhesive film for a set period of time to irradiation with UV light having a wavelength between 240 and 320 nm.

It is preferred that the detaching step include subjecting the adhesive film for a set period of time to irradiation with UV light having a wavelength between 320 and 400 nm.

If is preferred that the set period of time be between 50 and 70 seconds.

It is preferred that when the substrate is separated from the carrier, the carrier film of the adhesive film remain on the carrier. After the substrate is removed, the film can easily be detached from the carrier without jeopardizing the substrate.

It is preferred that when the substrate is separated from the carrier, the carrier film of the adhesive film remain on the substrate. This can be desirable in order to leave the film on the substrate as protection.

It is preferred that when the substrate is separated from the carrier, the carrier film of the adhesive film be detached both from the carrier and from the substrate. In this way, the adhesive film and any remnants thereof can be disposed of immediately.

According to a further aspect of the present invention, a substrate is provided that has been prepared by a method according to the above-described method. Since the adhesive film can be removed without leaving a residue, this substrate does not have to be cleaned before undergoing further processing and does not present any troublesome residues.

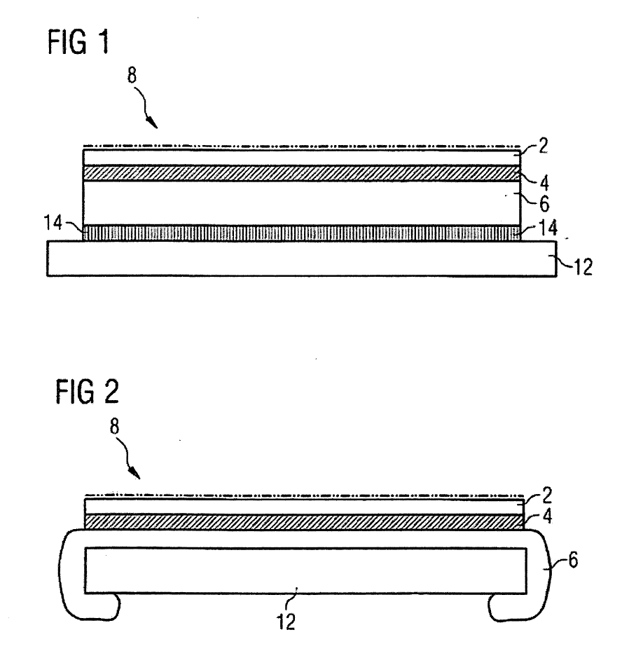

FIG. 1 shows a substrate bonded to a carrier by means of an adhesive film.

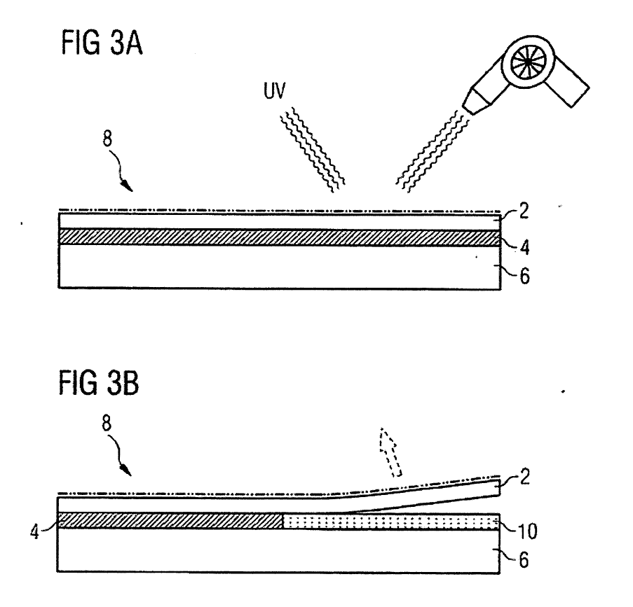

FIG. 2 shows a substrate mounted on a carrier by the stretch application of an adhesive film.

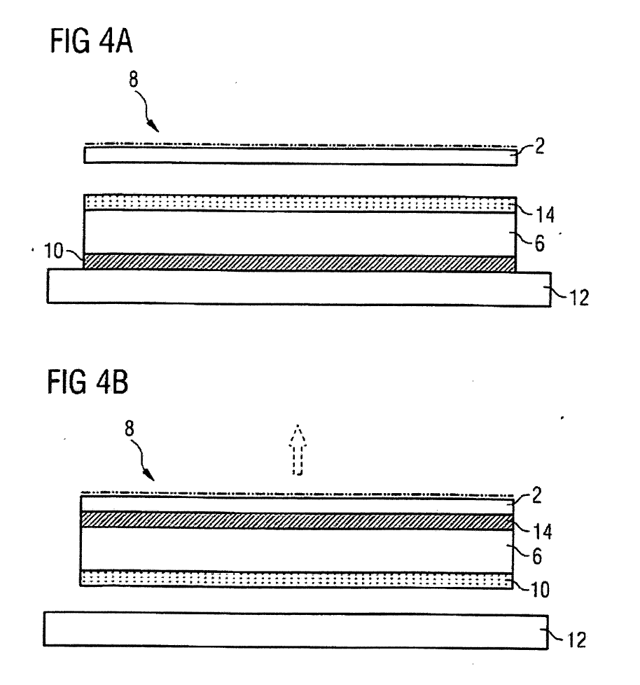

FIGS. 3a and 3b are simplified schematic illustrations of the inventive separation of the substrate and the carrier by means of a temperature step or UV irradiation.

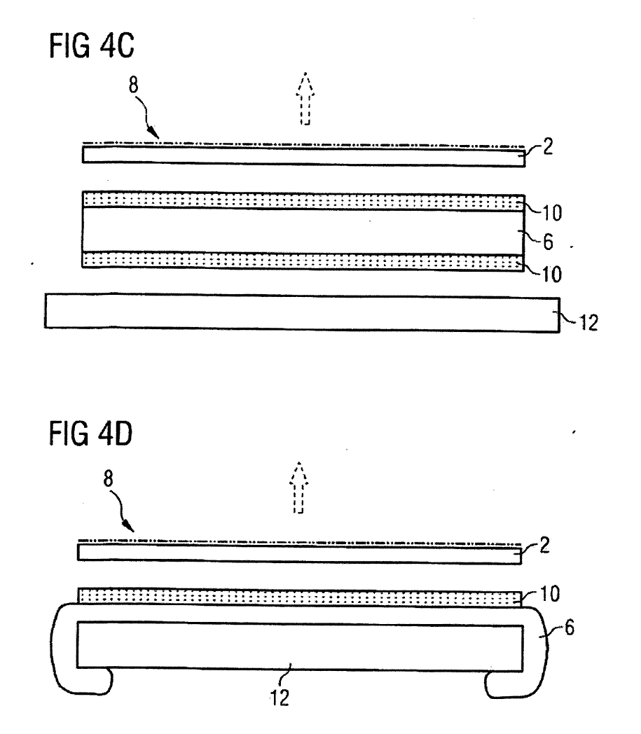

FIGS. 4a, 4b, 4c and 4d show different inventive variants of the detachment of the adhesive film. FIG. 4a shows the case in which the adhesive film remains on the carrier; 4b the case in which the adhesive film remains on the substrate; 4c the variant in which the adhesive film is detached completely, i.e., both from the carrier and from the substrate; and 4d an example in which the stretch-applied adhesive film remains on the carrier and is detached from the substrate.

FIG. 1 shows how a substrate 2 is adhesive-bonded to a carrier 12. The carrier 12 in this case can be, for example, a glass carrier, thus permitting inspection from the back during the fabrication of the end products or backlighting in the case of lithographic techniques. Any other suitable carrier can be contemplated with equal validity, however. A double-sided adhesive film composed of a carrier film 6 and two adhesive layers 4 and 14 holds substrate 2 on carrier 12. Adhesive layers 4 and 14 can be either identical or different. For example, layer 4 can be an adhesive layer whose adhesive action can be canceled according to the invention, while layer 14 can be a conventional adhesive layer whose adhesive action is not, or not completely, canceled by the detaching step. Other combinations are also conceivable, of course, insofar as is necessary or advantageous. Schematically depicted on substrate 2 in the figure are component structures 8, which symbolize structures prepared on or in the substrate and designed for organic semiconductor components.

FIG. 2 shows how a substrate 2 is stretch-applied to a carrier 12. In this case, an adhesive film composed of a carrier film 6 and at least one adhesive layer 4 holds carrier 12 and substrate 2 together. The adhesive film is stretch-applied to carrier 12 for this purpose. This can be accomplished, as illustrated here, by stretching it around the edges of the carrier 12. An adhesive layer by which the adhesive film is bonded to the carrier 12 is not necessarily required for this purpose. However, analogously to FIG. 1, the adhesive film can also in this case comprise a second adhesive layer (not shown) that bonds it to carrier 12. But using a one-sided adhesive film provides the advantage that after the preparation and removal of the substrate 2, the film can be removed from the carrier 12 just as it is, without the use of solvents or mechanical means. In the example shown, the film can be removed merely by guiding it back up over the edges.

FIGS. 3a and 3b illustrate the detaching step according to the inventive method. In this step, a substrate 2 (with component structures 8 thereon) is detached from an adhesive film composed of carrier film 6 and adhesive layer 4. A possible second adhesive layer is not shown, nor is the carrier to which the film adheres. This figure is intended to elucidate only the basic procedure of the inventive method. In one variant, the detaching step includes a temperature step, illustrated symbolically by a hot air gun. The adhesive film is thus exposed to a given temperature. This can be done from the top, i.e. the substrate side, as shown in the figure. However, the side from which the heat radiates to the adhesive film is not a crucial matter. It is equally conceivable for the requisite heat quantity to be introduced from the bottom (the carrier side), for example in order to spare the sensitive substrate. Since organic materials are sensitive to temperature, this is desirable. To this end, for example the carrier can be selected to have a much higher thermal conductivity than the substrate. In addition, the adhesive layer 4 can be selected so that it absorbs the bulk of the heat introduced (from below), while the substrate, above it, remains largely insulated and is thereby spared. The required temperature can be applied by any suitable conventional method, for example by electromagnetic irradiation or by contact with hot air. As a further alternative, irradiation with UV light is illustrated in the figure; UV-A, UV-B and UV-C can be used for this purpose. In other respects, irradiation works in exactly the same way as the temperature step.

FIG. 3b shows how the adhesive action of adhesive layer 4 has been canceled in a region 10 by the detaching step. The illustration should be considered symbolic, since in practice the material of adhesive layer 4 will ordinarily detach completely and residue-free. Substrate 2 can now be detached in this region 10 (illustrated by the arrow). Detachment by lifting off in a wedge shape is depicted only schematically here and serves merely to make the illustration clearer. In practice, the adhesive action of adhesive layer 4 will ordinarily be canceled completely and the substrate 2 will be deformed as little as possible during detachment (which occurs over the entire area at once, insofar as possible) and remains approximately flat during the process (roughly full-area detachment).

In the case of a double-sided adhesive film, either only one side can be coated with the adhesive material whose adhesive action is canceled or both sides can be coated with it. If only one side is coated, the second adhesive layer can be composed of ordinary adhesive material, i.e., a material whose adhesive action is substantially resistant to the detaching step. The base material or the carrier film of the adhesive film will then usually remain on the carrier due to this conventional adhesive. It is, however, equally possible to leave the carrier film of the adhesive film on the prepared substrate, for example as protection, when it makes sense to do so.

Another way of making the attachment to a carrier is to stretch-apply the adhesive film, with the substrate film sticking to it, to the carrier. Here, the elasticity of the adhesive film is used to affix it mechanically to the carrier. An adhesive material is not necessarily required for this purpose, since the tension keeps the film on the carrier. In the stretch-application of an adhesive film that is adhesively bonded to the substrate by a side coated with adhesive, the carrier material from the adhesive film that remains after detachment of the substrate can also be removed from the carrier (glass, etc.) without residue-free, since the adhesive film is merely stretch-applied. The adhesive holding the substrate and the adhesive film together is divested of its adhesive action by the temperature step or by UV irradiation. After the substrate is removed from the carrier, the stretch-applied film that remains can then be removed simply and easily, without leaving any chemical residues behind and without the application of great mechanical force. Glass or similar carriers to which the film is stretch-applied are not damaged in the process and can theoretically be reused.

The following details, in particular, must be considered when choosing an adhesive film. If the adhesive action of the adhesive layer is to be canceled by a temperature step, care must be taken to ensure that the temperature remains well below the detachment temperature during all the method steps concerned. Otherwise, there is a risk that the substrate will detach prematurely from the carrier, which might compromise the end product. In the worst case, the substrate would have to be discarded. In addition, the detachment temperature itself must, of course, be selected so that during the final detaching step the temperature remains low enough not to damage the end product.

It will normally be desirable for the adhesive film, or at least the adhesive layer, to absorb the applied heat well and possibly for the substrate to be largely thermally insulated, e.g. in cases where heat is applied to the carrier side as described above. The analogous case applies to film that can be detached by means of UV radiation.

The selection of the film and its properties will therefore represent a compromise between good adhesion during the preparation process and the easiest possible removability thereafter. In addition, it is, of course, equally necessary to find a compromise between easy removability and doing as little damage as possible to the substrate and the components prepared on it. The most important parameters in this regard are the temperature or the irradiation intensity and the duration of exposure.

It should be noted that although this description refers essentially to an adhesive film comprising a carrier film and at least one additional layer of adhesive material, the invention is not limited to such an adhesive film. The film can also, according to the invention, be composed solely of adhesive material.

The following embodiments, among others, can also be realized with the inventive method described in the foregoing.

In a first inventive embodiment, a film substrate (a thin glass substrate) for displays, photodetectors or electrochromic display units is stretch-applied to a carrier by means of the adhesive film. In this case, the carrier film is selected in optimum fashion specifically for each method e.g. lithography, metallization, cleaning, etc.).

In a second inventive embodiment, a film substrate (a thin glass substrate) for displays, photodetectors or electrochromic display units is stretch-applied to a carrier by means of the adhesive film. In this case, the film is selected so that all the method steps necessary for fabricating the corresponding semiconductor components are carried out. That is, the film is selected so that it is not compromised during any of the method steps, particularly in the form of undesired premature detachment due to breakdown of the adhesive layer.

In a third inventive embodiment, a film substrate (a thin glass substrate) for displays, photodetectors or electrochromic display units is adhesively bonded to a carrier by means of the adhesive film. After processing, the film substrate is detached from the carrier residue-free by means of a temperature step (90° C., 120° C., 150° C. or 170° C. for one minute, depending on the design). In this case, the film is selected so that all the temperatures that occur during the preparation process are below the detachment temperature. At the same time, the necessary detachment temperature must not cause any damage to the end product.

In a fourth inventive embodiment, a film substrate (a thin glass substrate) for displays, photodetectors or electrochromic display units is stretch-applied to a carrier by means of an adhesive film. After the substrate has been processed, it is removed from the carrier without leaving a residue. In this case, the adhesive layer of the film is broken down by UV irradiation. UV-A, UV-B and UV-C can be used for this purpose. Introducing a specific dose of UV radiation into the film causes the film to break down without subjecting the product to thermal stress.

1. A method of preparing a substrate for the fabrication of organic semiconductor components, the method comprising:
affixing a substrate to a carrier via an adhesive film;
preparing said substrate; and
canceling the adhesive action of the adhesive film so that said substrate can be separated from said carrier.

2. The method as recited in claim 1, wherein said adhesive film is coated with adhesive on both sides and wherein the affixing of said substrate to said carrier includes:
adhesively bonding said adhesive film to said carrier; and
adhesively bonding said substrate to the side of said adhesive film facing away from said carrier.

3. The method as recited in claim 1, wherein said adhesive film is coated with adhesive on at least one side and wherein the mounting of said substrate on said carrier includes:
stretch-applying said adhesive film to said carrier, a side coated with adhesive being disposed on the side facing away from said carrier;
adhesively bonding said substrate to said side of said adhesive film that is coated with adhesive and faces away from said carrier.

4. The method as recited in claim 1, wherein said adhesive film is composed of a layer of adhesive material whose adhesive action is canceled by said detaching step.

5. The method as recited in claim 1, wherein said adhesive film comprises a carrier film and at least one layer of adhesive material whose adhesive action is canceled by said detaching step.

6. The method as recited in claim 1, wherein said adhesive film comprises a carrier film and two layers of adhesive material, at least one of which two layers comprises an adhesive material whose adhesive action is canceled by said detaching step.

7. The method as recited in claim 6, wherein one of said two layers comprises an adhesive material whose adhesive action is not canceled by said detaching step.

8. The method as recited in claim 1, wherein said detaching step includes exposing said adhesive film to a set temperature for a set period of time.

9. The method as recited in claim 8, wherein said set temperature is between 80° C. and 110° C.

10. The method as recited in claim 8, wherein said set temperature is between 110° C. and 140° C.

11. The method as recited in claim 8, wherein said set temperature is between 140° C. and 160° C.

12. The method as recited in claim 8, wherein said set temperature is between 160° C. and 180° C.

13. The method as recited in claim 1, wherein said detaching step includes subjecting said adhesive film for a set period of time to irradiation with UV light having a wavelength between 100 and 240 nm.

14. The method as recited in claim 1, wherein said detaching step includes subjecting said adhesive film for a set period of time to irradiation with UV light having a wavelength between 240 and 320 nm.

15. The method as recited in claim 1, wherein said detaching step includes subjecting said adhesive film for a set period of time to irradiation with UV light having a wavelength between 320 and 400 nm.

16. The method as recited in claim 8, wherein said set period of time is between 50 and 70 seconds.

17. The method as recited in claim 6, wherein when said substrate is separated from said carrier, said carrier film of said adhesive film remains on said carrier.

18. The method as recited in claim 6, wherein when said substrate is separated from said carrier, said carrier film of said adhesive film remains on said substrate.

19. The method as recited in claim 6, wherein when said substrate is separated from said carrier, said carrier film of said adhesive film is detached both from said carrier and from said substrate.

20. (canceled)

21. A system, comprising:
a substrate;
a carrier layer;
a carrier film between the substrate and the carrier layer; and
an adhesive layer between the substrate and the carrier layer,
wherein the system comprises a portion of an organic semiconductor.
